(19) United States
(12) Patent Application Publication
(10) Pub. No.: US 2003/0177133 A1
(43) Pub. Date: Sep. 18, 2003

(54) Method and device for managing vehicle related services

(75) Inventor: Shigehisa Hikida, Yachiyo-shi (JP)

Correspondence Address: SHINJYU GLOBAL IP COUNSELORS, LLP, 1233 20TH STREET, NW, SUITE 700, WASHINGTON, DC, 20036-2680, US

(73) Assignee: Nissan Motor Co., Ltd., Yokohama-shi (JP)

(21) Appl. No.: 10/357,475

(22) Filed: Feb. 4, 2003

(30) Foreign Application Priority Data
Mar. 15, 2002 (JP) JP 2002-071255

(51) Int. Cl. G06F 17/00

(52) U.S. Cl. 707/100

(57) ABSTRACT

A method of managing information regarding vehicles and customers is provided in which information regarding vehicle and customers are stored in a consolidated manner after the vehicle has been sold. The method is basically accomplished by creating a management database that is based on customer information received from a sales company and vehicle information received from a vehicle manufacturer. The management database integrates the aforementioned two types of information at a management center. Service information received from a service entity is sent to the sales company such that the service information can be presented to the customer. The customer information containing details regarding services contracted by the customer is sent to the service entity. Two-way communications are conducted between the management center and each customer to manage additions/changes to the customer information and contracted services.

### BACKGROUND OF THE INVENTION

1. Field of the Invention

The present invention generally relates to a vehicle related service management method and management device for conducting in a consolidated manner various services related to a vehicle after the vehicle has been sold. More specifically, the present invention relates to managing vehicle related information at a management center such that the information can be used by various vehicle related entities after the vehicle has been sold.

2. Background Information

Conventionally, vehicle sales are conducted separately by sales companies and sales stores (hereinafter referred to collectively as “sales entities”) in each sales chain and each region. The information regarding customers who purchased vehicles is stored separately by each sales entity and services such as regular maintenance are also conducted separately through each sales entity. Meanwhile, information regarding vehicles sold is stored at the manufacturers who made the vehicles. Furthermore, such services as vehicle insurance for accidents and vehicle problems are provided by service entities of insurance companies who create plans independently and contract each service separately to each customer either independently or through a sales entity.

In view of the above, it will be apparent to those skilled in the art from this disclosure that there exists a need for an improved method and/or device for managing these vehicle related services. This invention addresses this need in the art as well as other needs, which will become apparent to those skilled in the art from this disclosure.

### SUMMARY OF THE INVENTION

It has been discovered that in the conventional methods, described above, various information regarding vehicles that were sold and information of the respective customers are stored separately by the sales entities, the vehicle manufacturers, and the service entities. Moreover, each service is contracted separately. Consequently, the contract procedure and judgment of service details to be accomplished by customers who purchase vehicles is complicated and since the various types of information are scattered about, it is difficult to utilize the information in an efficient manner.

The present invention was conceived in order to solve these problems in the conventional methods described above. One object is to provide a vehicle related service management method and management device for conducting in a consolidated manner various services related to a vehicle after the vehicle has been sold.

The aforementioned object can be basically attained by a method for managing vehicle related services that comprises creating a management database including customer information received from at least one sales entity regarding customers and vehicle information received from at least one vehicle manufacturer regarding vehicles that were sold, sending service information to at least one of the sales entities such that at least a portion of the service information can be presented to the customers, sending at least a portion of the customer information containing details regarding services contracted by the customers to the service entity; and conducting communications between the management center and each of the customers to manage at least one of the customer information and the services contracted by the customers. The management database is configured to integrate the customer information and the vehicle information at a management center.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram showing the entire flow of the present invention;

FIG. 2 is a flowchart showing the processing executed by the management center in the present invention;

FIG. 3 is a block diagram showing an embodiment of a management device in accordance with present invention; and

FIG. 4 is a simplified block diagram of the management center processing device showing in accordance with present invention.

### DETAILED DESCRIPTION OF THE PREFERRED EMBODIMENTS

Selected embodiment of the present invention will now be explained with reference to the drawings. It will be apparent to those skilled in the art from this disclosure that the following descriptions of the embodiment of the present invention are provided for illustration only and not for the purpose of limiting the invention as defined by the appended claims and their equivalents.

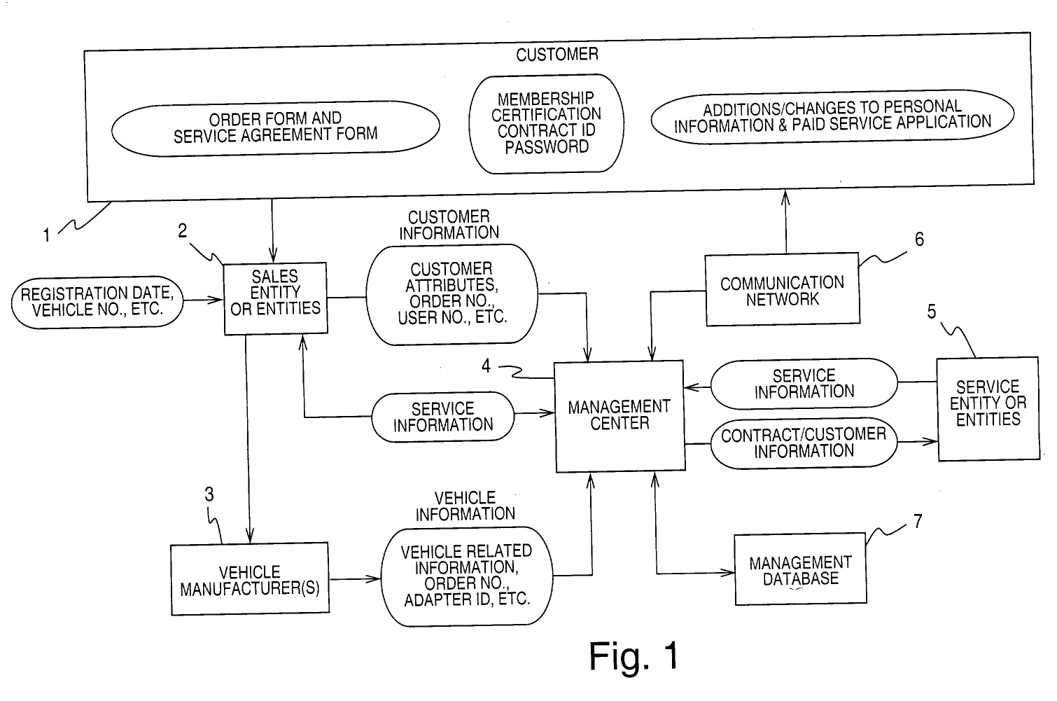

Referring initially to FIG. 1, a block diagram illustrates the entire flow of information in a vehicle related service management method in accordance with a first embodiment of the present invention. The vehicle related service management method basically involves managing customer information and vehicle information in a consolidated manner for providing various services related to a vehicle after the vehicle has been sold.

As seen in FIG. 1, each customer 1 who will purchase a vehicle submits an order form and a service agreement form to a sales company 2 such as an automobile dealership. The order form is a document formally indicating the customer's intention to purchase the vehicle and the service agreement form is a document indicating that the customer has agreed to receive insurance and other vehicle related services (discussed later). This customer information is preferably communicated to the vehicle manufacturer 3 and a management center or company 4, which in turn communicates the customer information to at least one service entity 5 as discussed below in more detail. The customers can also access information on their vehicles and/or service agreements via a two way communication network 6 as discussed below in more detail. It will be apparent to those skilled in the art from this disclosure that the vehicle related service management method of the present invention preferably involves a plurality of sales companies 2 and a plurality of service entities 5. Moreover, it will be apparent to those skilled in the art from this disclosure that the vehicle related service management method of the present invention can involve one or more vehicle manufacturers 3. Thus, while the following description will typically only refers to one customer, one sales company, one vehicle manufacturer and one service entity, it will be apparent to those skilled in the art from this disclosure that the follow description of the vehicle related service management method of the present invention applies to a plurality of customers 1, a plurality of sales companies 2, a plurality of vehicle manufacturers 3 and a plurality of service entities 5 that all communicate with the management center 4.

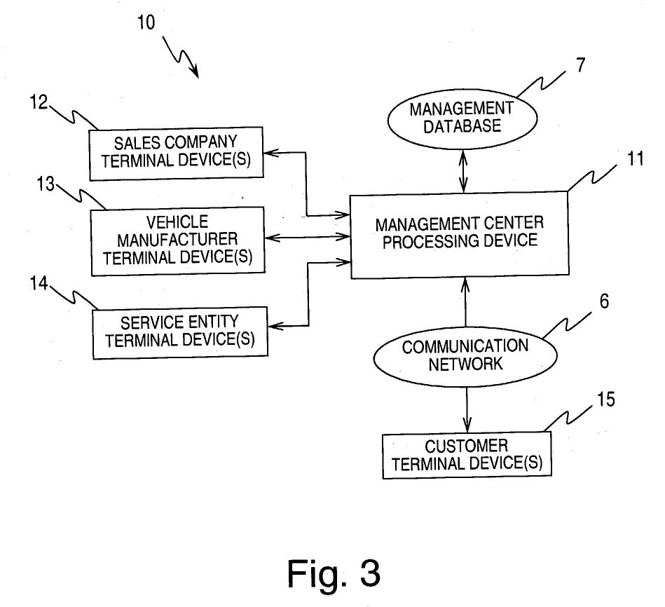

Referring briefly to FIG. 3, a management device 10 is illustrated in accordance with present invention as a block diagram. The management device 10 basically includes a management center processing device 11, one or more sales company terminal devices 12, one or more vehicle manufacturer terminal devices 13, one or more service entity terminal devices 14, and one or more customer terminal devices 15. The management center processing device 11 is preferably located at the management center 4 and is configured to access and manipulate the date within the management database 7. The management center processing device 11 is configured to communicate with the customer terminal devices 15 through the communication network 6. The management device 10 will be discussed in more detail below.

As seen in FIG. 1, the sales company 2 sells the vehicle, which is procured from the vehicle manufacturer 3, in accordance with the aforementioned order form. When the vehicle is registered, the sales company 2 receives various vehicle related information such as a registration date and a vehicle number for the sold vehicle through the sales company terminal device 12 and records this information. Then, the sales company 2 sends customer information and the registration information to the management center 4. The customer information preferably includes at least the name of the customer 1 who purchased the vehicle, the address and other attributes of the customer 1, contract information containing details regarding the services the customer 1 contracted (hereinafter called “contract/customer information”), the order number, the user number (number assigned to each customer), etc. When it is not necessary to be specific, the aforementioned registration information, contract/customer information, customer attribute information, etc., are collectively referred to hereinafter as “customer information.”

In response to information received from the sales company 2, the vehicle manufacturer 3 sends the vehicle information for the sold vehicle to the management center 4. The vehicle information includes such information regarding the sold vehicle as the model, the grade, information regarding optional components, order number, adapter ID for vehicles equipped a navigation/communication device, etc. It is acceptable for the sales company 2 and the vehicle manufacturer 3 to communicate with each other directly, but the invention can also be configured such that they communicate through the management center 4.

The management center 4 creates and stores a management database 7 using the customer information and vehicle information it receives. When it receives registration information from the sales company 2, it stores that information in the management database 7, as well. The management center 4 then sends required portions of the management database 7 to the customer 1, the sales company 2, and the service entity 5 (e.g., a collision insurance company) with whom the customer 1 has formed a contract.

The service entity 5 prepares information regarding service details, e.g., a plurality of service plans combining various types of services, and sends the information to the sales company 2 through the management center 4. The sales company 2 presents the information materials to the customer 1 for selecting services at the time of purchase. Meanwhile, the service entity 5 records the customer 1 who contracted services based on contract/customer information (name and address of customer who entered contract, details regarding services contracted, etc.) received from the management center 4.

As mentioned above, while FIG. 1 only shows one service entity 5, it is also acceptable for there to be separate service entities 5 for each type of vehicle related service, e.g., insurance, credit, and other paid services (discussed later). It is also acceptable for service plans that combine various services to be prepared at the management center 4 based on materials received from the individual service entities 5. In other words, a single service plan can includes services from different ones of the service entities 5 in the same plan. Thus, the services of the individual service entities 5 do not need to be separately contracted.

The actual services to be rendered under the service plan or contract to the customer 1 are provided directly to the customer 1 by the services entities 5. However, the customer 1 preferably directly contacts the management center 4 and then the management center 4 contacts the appropriate one of the services entities 5, which will then render the actual service to the customer 1. Alternatively, it is also possible for the customer 1 to directly contact the service entities 5 regarding services to be rendered, e.g., vehicle maintenance, accident claims and the like, under the service plan or contract.

The management center 4 sends a certification ID (membership certification, contract ID, password, etc.) to each of the customers 1. This certification ID certifies that a contract was formed with the customer 1 and uses the contract ID and password to communicate with each of the customers 1 through the communication network 6, e.g., a mobile telephone, internet, or other communication network 6. By communicating in this manner, the management center 4 sends information regarding new services and other information to the customers 1, and the customers 1 send additions and/or changes to personal information, additional applications for paid services, and other information to the management center 4. These additions and changes are stored in the database 7.

Examples of paid services that are provided by the vehicle related service management method of the present invention include, but not limited to: (1) roadside assistance with expense compensation; (2) emergency notification service; (3) navigation operation agent service; (4) Auto DJ; and (5) roadside assistance.

The roadside assistance with expense compensation is a service that covers expenses for towing, repair, transportation, lodging, etc., when vehicle problems or an accident occurs on a highway or in a remote area. Sometimes it is provided free of charge for a prescribed period after a new vehicle is purchased.

The emergency notification service is a service that automatically detects when an airbag has deployed and informs relevant parties (the rescue number of fire department, a pre-registered contact person, etc.) that an accident has occurred.

The navigation operation agent service is a service that will guide the driver to a destination. Since it is troublesome for the driver to operate the navigation system while driving, the driver can connect to the service with a mobile telephone and the service center will perform the navigation operations and display the results on the vehicle navigation system. On example of such a system available in Japan is CPL.

The Auto DJ is an information service for automobiles. It can only be used by a user who has a specific contract ID.

The roadside assistance is a service that performs roadside repair and towing when a vehicle breaks down or an accident occurs while operating the vehicle. On example of such a service available in Japan is JAF (Japan Automobile Federation) Road Service.

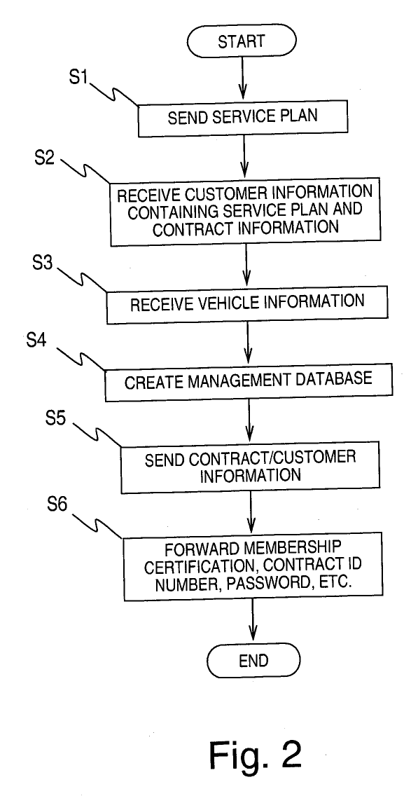

Referring now to FIG. 2, a flowchart is illustrated that shows the processing operations that are executed by the management center 4 in carrying out the vehicle related service management method of the present invention.

In step S1, the management center 4 prepares a plurality of service plans (service information), based on information received from at least one of the service entities 5, and then sends the service plans to at least one of the sales entities 2 such that the service information can be presented to the customers 1. Each of the service plans comprises one or more services. The service plans can be prepared in advance by the service entities 5 and then completed service plans are presented to the management center 4 for distribution. Alternatively, the management center 4 creates the service plans that combine various services provided by the service entities 5. In any case, the management center 4 sends this service information to the sales company 2. The sales company 2 presents the content of the service information (via a terminal screen, catalog, or pamphlet) to the customers 1 who have purchased or plan to purchase a vehicle.

In step S2, the management center 4 receives customer information from the sales company 2. The customer information contains information (registration information, etc.) regarding the service plan that the customer 1 has selected and contracted when the customer 1 entered into the vehicle purchase contract. Thus, the customer 1 can contract various services related to the vehicle (e.g., collision insurance, credit, specified paid services) collectively by selecting and contracting one of the service plans.

In step S3, the management center 4 receives vehicle information regarding the sold vehicle from the vehicle manufacturer 3.

In step S4, the management center 4 creates the management database 7 that compiles the aforementioned customer information (including contract/customer information and registration information) and the vehicle information at the management center 4.

In step S5, the management center 4 sends contract/customer information to the service entities 5. In response, the service entities 5 store and manage the information regarding contracts of the customers 1.

In step S6, the management center 4 sends a certification ID (membership certification, contract ID number, password, etc.) to the customer 1. The certification ID is used regarding service, inquiries, and the forwarding of catalogs and pamphlets thereafter.

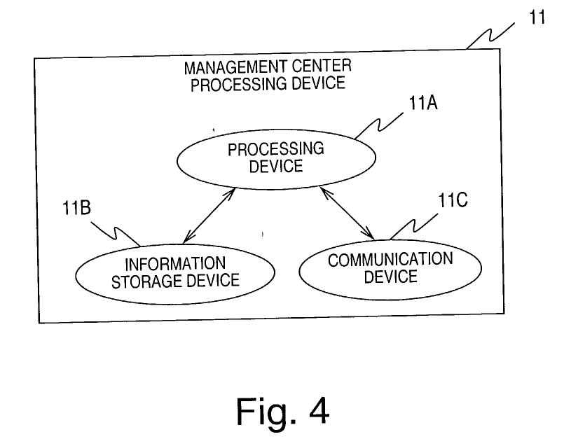

Referring now to FIGS. 3 and 4, block diagrams illustrate one embodiment of the management device 10 for realizing the management method of the present invention. The management center processing device 11 is a computer provided in the management center or company 4 that controls the exchange of data between the terminal devices 12, 13, 14 and 15. The management center processing device 11, as seen in FIG. 4, preferably includes a central processing unit (CPU) or processing device 11A, an information storage device 11B and a two-way communication device 11C. The processing device 11A is configured to integrate and manage the customer information, the vehicle information and the service information stored in the information storage device 11B. The communication device 11C is configured to receive and send customer information, vehicle information and service information. The information storage device 11B is configured to read and write the customer information, the vehicle information and the service information to the management database 7 stored in the information storage device 11B. The processing device 11A is operatively coupled to the two-way communication device 11C and the information storage device 11B so as to (1) receive and process the customer information from at least one sales entity 2, (2) receive and process the vehicle information regarding a sold vehicle from at least one vehicle manufacturer 3, (3) receive and process the service information regarding various services provided from the service entity 5, (4) send the customer information containing details regarding services contracted by the customers to the service entity 5, (5) send the service information to the sales entity 2, (6) send required information to the customers 1, and (7) receive and process information containing additions/changes to the customer information and contracted services from the customers 1.

The management center processing device 11 has a management control program that controls the writing and reading of data to and from the management database 7. The information storage device 11B is a readable/writable memory or storage device such as a ROM (Read Only Memory) device or a hard drive that allows for management of the management database 7 by the processing device 11A. The management center processing device 11 also includes other conventional components such as an input device, an input interface circuit, an output interface circuit, and other storage devices such as a ROM (Read Only Memory) device and a RAM (Random Access Memory) device.

The sales company terminal device 12 is a computer installed at each sales company 2 into which at least information regarding the customer 1 purchasing a vehicle (name, address, contract/customer information, etc.) and registration information regarding the registration of the vehicle are entered and sent to the management center processing device 11. The sales company terminal device 12 also receives service information sent from the management center processing device 11. The sales company terminal device 12 preferably includes a sales company control program that controls the processing of the customer information and service information that is inputted and stored in a ROM (Read Only Memory) device or on its hard drive. The sales company terminal device 12 also includes other conventional components such as an input device, an input interface circuit, an output interface circuit, and other storage devices such as a ROM (Read Only Memory) device and a RAM (Random Access Memory) device.

The vehicle manufacturer terminal device 13 is a computer installed at the vehicle manufacturer 3. Based on the sales information received from the sales company terminal device 12, the vehicle manufacturer terminal device 13 sends the vehicle information related to the sold vehicle to the management center processing device 11. The vehicle manufacturer terminal device 13 preferably includes a control program that processes the sales information and the vehicle information that are stored in a ROM (Read Only Memory) device or on its hard drive. The vehicle manufacturer terminal device 13 also includes other conventional components such as an input device, an input interface circuit, an output interface circuit, and other storage devices such as a ROM (Read Only Memory) device and a RAM (Random Access Memory) device.

The service entity terminal device 14 is a computer installed at the service entity 5. The service entity terminal device stores contract/customer information received from the management center processing device 11 and sends service information equivalent to service plans that combine various types of services to the management center processing device 11. The service entity terminal device 14 preferably includes a control program that processes the contract/customer information and the service information that are stored in a ROM (Read Only Memory) device or on its hard drive. The service entity terminal device 14 also includes other conventional components such as an input device, an input interface circuit, an output interface circuit, and other storage devices such as a ROM (Read Only Memory) device and a RAM (Random Access Memory) device.

The exchange of information between the management center processing device 11 and the sales company terminal device 12, the vehicle manufacturer terminal device 13, and the service entity terminal device 14 is conducted through a dedicated circuit or through a two-way communication network, such as the internet.

The communication network 6 is equipped with functions that allow the management center processing device 11 and the customer terminal devices 15 to conduct two-way communication. Thus, the communication network 6 is preferably the internet or another two-way communication network that can easily carry out the processes of the present invention.

The customer terminal device 15 is a computer or mobile telephone that can access the management center processing device 11 through the communication network 6. The customer terminal device 15 serves to receive information regarding new services from the management center processing device 11, and send information from the customer 1 regarding additions and changes to personal information, applications for paid services, etc. to the management center processing device 11. Also, although it is possible for the customer to contact the service entities 5 directly when an accident or vehicle problem occurs, the management method is preferably configured and arranged such that the customer 1 contacts the service entities 5 through the management center processing device 11.

As described above, the present invention compiles customer information from the sales companies 2 and vehicle information from the vehicle manufacturers 3 in one place (the management center 4) and conducts all services related to a vehicle in a consolidated manner. As a result, it is anticipated that the several beneficial effects will be obtained by the customer 1, the sales entity 2, the management center 4 (management entity established by a vehicle manufacturer or the like), and the service entity 5.

Generally, since the present invention involves the management center 4 collecting the customer information from the sales entities 2 and managing the information intensively, the invention creates the possibility of demanding beneficial plans from external service entities. When a customer purchases a vehicle, he or she can enter into various types of service contracts with one collective application. As a result, the process is simplified and various service plans can be investigated in a consolidated manner, making it possible to compare the content of many different contracts efficiently and easily. Since the sales entities 2 can hand subsequent services over to the management center 4 by simply sending the customer information, their work is simplified and there is the possibility that they can reduce costs. Since the service entities 5 can obtain a large number of contract from the customers, they can reduce costs and there is the possibility that they can use the difference to create plans that are more beneficial to the customers 1.

Now the beneficial effects of the present invention will be discussed in more detail for each entity of the method.

(1) Management Center or Company

The management center 4 can gather information regarding customers 1 from the sales entities 5. Conventionally, even the sales companies 2 affiliated with the same manufacturing chains have not revealed information to each other regarding their own customers and, thus, it has not been possible to share and use information even within the same chain. The present invention, however, makes it possible to improve service by gathering information in one place. For example, if most of the customers 1 of the large vehicle manufacturers are gathered together, the customers 1 will number from several hundred thousand to several million and there will be the possibility of demanding beneficial plans from collision insurance companies and other external service entities 5. Also, by creating plans that combine collision insurance, roadside service, and the like, beneficial services can be provided inexpensively. Finally, by including credit card companies, fees can also be paid at the same time.

(2) Customers

When the customer 1 purchases a vehicle from one of the service entities 5, he or she can apply for collision insurance, credit, roadside assistance, roadside assistance with expense compensation, etc., with a single collective application. As a result, there is the possibility that prices can be reduced because the procedure is simplified and services are contracted collectively. Furthermore, since the various service plans combine such services as collision insurance and road service in a consolidated manner, it is possible to investigate many services at once in a single document, instead of merely investigating the content of each contract separately. Thus, it is possible to compare the content of many different contracts efficiently and easily.

(3) Sales Companies

Since the sales entities 2 can hand subsequent services over to the management center 4 by simply sending the customer information to the management center 4 when a vehicle is sold, their work is simplified and they can reduce costs. Also, since the information is compiled in one place, the number of contract customers is extremely large and there is the possibility that the prices for collision insurance and other services will decrease. Consequently, it is possible to provide services that are more beneficial than in the case of conventional small-scale sales companies operating individually and there is the possibility that vehicles will become easier to sell.

(4) Service Entities

Since a large number of contract customers can be gathered, costs can be reduced and the difference can be used to create plans that are more beneficial to customers 1. As a result, there is the possibility of both increasing profits and gaining an advantage over other companies in the same industry.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially”, “about” and “approximately” as used herein mean a reasonable amount of deviation of the modified term such that the end result is not significantly changed.

This application claims priority to Japanese Patent Application No. 2002-71255. The entire disclosure of Japanese Patent Application No. 2002-71255 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A method for managing vehicle related services comprising:
creating a management database including customer information received from at least one sales entity regarding customers and vehicle information received from at least one vehicle manufacturer regarding vehicles that were sold, the management database being configured to integrate the customer information and the vehicle information at a management center;
sending service information to the sales entity such that at least a portion of the service information can be presented to the customers;
sending at least a portion of the customer information containing details regarding services contracted by the customers to the service entity; and
conducting communications between the management center and each of the customers to manage at least one of the customer information and the services contracted by the customers.

2. The method as recited in claim 1, further comprising
processing a service plan based on at least a portion of the service information;
sending the service plan to the sales entity from the management center such that the service plan can be presented to the customers;
receiving at the management center the portion of the customer information containing details regarding the services contracted by the customers from the sales entity;
sending the portion of the customer information containing details regarding the services contracted by the customers from the management center to the service entity; and
sending from the management center a contract certification ID to the customers to enable a service contact to be made thereafter.

3. The method as recited in claim 1, further comprising
processing a service plan based on at least a portion of the service information, and sending the service plan to the sales entity from the management center such that the service plan can be presented to the customers.

4. The method as recited in claim 3, further comprising
creating the service plan at the service entity.

5. The method as recited in claim 3, further comprising
creating the service plan at the management center that includes services from a plurality of the service entities.

6. The method as recited in claim 1, further comprising
receiving at the management center the portion of the customer information containing details regarding the services contracted by the customers from the sales entity.

7. The method as recited in claim 1, further comprising
sending the portion of the customer information containing details regarding theservices contracted by the customers from the management center to the service entity.

8. The method as recited in claim 1, further comprising
sending from the management center a contract certification ID to the customers to enable a service contact to be made thereafter.

9. A method for managing vehicle related services comprising:
processing a service plan based on service information received at a management center;
sending the service plan to at least one sales entity from the management center such that the service plan can be presented to customers;
receiving at the management center customer information containing details regarding services contracted by the customers from the sales entity;
receiving at the management center vehicle information regarding a purchased vehicle from at least one vehicle manufacturer;
compiling the customer information and the vehicle information at the management center to create a management database;
sending at least the portion of the customer information containing details regarding the services contracted by the customers from the management center to the service entity; and
sending from the management center a contract certification ID to the customers to enable a service contact to be made thereafter.

10. A management center processing device comprising:
a two-way communication device configured to receive and send customer information, vehicle information and service information;
an information storage device configured to read and write the customer information, the vehicle information and the service information to a management database stored in the information storage device; and
a processing device to integrate and manage the customer information, the vehicle information and the service information, the processing device being operatively coupled to the two-way communication device and the information storage device so as to
process the customer information received from at least one sales entity,
process the vehicle information regarding a sold vehicle received from at least one vehicle manufacturer,
process the service information regarding various services provided from the service entity,
send at least a portion of the customer information containing details regarding services contracted by customer to the service entity,
send the service information to the sales entity,
send required information to the customers, and
process information containing modifications to the customer information and the services contracted by the customers.

11. The management center processing device as recited in claim 10, wherein
the processing device is further configured to create a service plan based on the service information, and send the service plan to the sales entity such that the service plan can be presented to the customers.

12. The management center processing device as recited in claim 10, wherein
the processing device is further configured to process the portion of the customer information containing details regarding the services contracted by the customers from the sales entity.

13. The management center processing device as recited in claim 10, wherein
the processing device is further configured to send the portion of the customer information containing details regarding the services contracted by the customers to the service entity.

14. The management center processing device as recited in claim 10, wherein
the processing device is further configured to send a contract certification ID to the customers to enable a service contact to be made thereafter.

15. A management device comprising:
communication means for receiving and sending customer information, vehicle information and service information;
storage means for reading and writing the customer information, the vehicle information and the service information to a management database stored in the storage means; and
processing means for integrating and managing the customer information, the vehicle information and the service information, the processing device being operatively coupled to the two-way communication device and the information storage device for
processing the customer information from at least one sales entity,
processing the vehicle information regarding a sold vehicle received from at least one vehicle manufacturer,
processing the service information regarding various services provided from the service entity,
sending the customer information containing details regarding services contracted by customer to the service entity,
sending the service information to the sales entity,
sending required information to the customers, and
processing information containing additions/changes to the customer information and contracted services received from the customers.

16. A vehicle information management system, comprising:
a management center device processing device including a management database that integrates customer information and vehicle information;
at least one customer terminal device operatively coupled to communicate with the management center processing device so as to send information containing additions/changes to the customer information and contracted services from customers to the management center processing device and receive required information from the management center processing device;
at least one sales entity terminal device operatively coupled to communicate with the management center processing device so as to send the customer information to the management center processing device and receive service information from the management center processing device;
at least one vehicle manufacturer terminal device operatively coupled to communicate with the management center processing device so as to send the vehicle information regarding a sold vehicle to the management center processing device; and
at least one service entity terminal device operatively coupled to communicate with the management center processing device so as to send the service information for a service plan to the management center processing device and receive the customer information containing details regarding services contracted by the customers from the management center processing device.

17. The vehicle information management system as recited in claim 16, further comprising
a plurality of the service entities that are operatively coupled to communicate with the management center processing device.
